(19) United States
(12) Patent Application Publication
(10) Pub. No.: US 2005/0284531 A1
(43) Pub. Date: Dec. 29, 2005

(54) Drill pipe assembly

(76) Inventor: Travis J. Threadgill, Rockport, TX (US)

Correspondence Address: GIFFORD, KRASS, GROH, SPRINKLE & CITKOWSKI, P.C, PO BOX 7021, TROY, MI, 48007-7021, US

(21) Appl. No.: 10/875,650

(22) Filed: Jun. 24, 2004

(51) Int. Cl. F16L 55/00

(52) U.S. Cl. 138/104

(57) ABSTRACT

A drill pipe assembly having an elongated tubular drill pipe constructed of a rigid material and open at each end. A layer of thermal insulation material is provided around the drill pipe between its ends. Optionally, en electronic component package is mounted to the drill pipe such that the package is sandwiched in between the layer of thermal insulation material and the drill pipe.

### BACKGROUND OF THE INVENTION

I. Field of the Invention

The present invention relates to drill pipes.

II. Description of Related Art

There are many previously known drill pipes of the type used for oil and/or natural gas exploration. These previously known drill pipes typically comprise an elongated tubular and cylindrical section with a drill bit mounted to the lowermost drill pipe section. Additional drill pipe sections are then attached to the uppermost drill pipe section as required as the depth of the drill hole increases.

Typically, electronic components, such as one or more electronic sensors together with their associated transmitter(s), batteries and other circuitry, are mounted in a sleeve attached to the lowermost section of the drill pipe. These electronic sensors provide information to the persons drilling the well of various parameters relevant to the drilling operation.

During a drilling operation, a slurry, commonly known as drilling mud, is pumped downwardly through the interior of the drill pipe. This drilling mud accomplishes a number of important functions.

First, the drilling mud acts as a lubricant for the drill bit during the drilling operation. Without this lubricant, the useful life of the drill bit would be greatly shortened.

Additionally, the temperature of the earth increases with the depth of the hole. Since the drilling mud is substantially at ambient temperature at the time that it is pumped into the drill pipe, the drilling mud also acts as a coolant for not only the drill pipe but also the electronic components mounted to the drill pipe.

Lastly, the drilling mud also serves to convey debris from the drilling operation. Specifically, the drilling mud, after it exits the bottom of the drill pipe, flows upwardly around the exterior of the drill pipe and carries the drilling debris to the surface.

One problem with the previously known drill pipes occurs during very deep drill holes, e.g. when the drill hole exceeds 12,000-15,000 feet. At such deep depths, the heat of the earth heats the drilling mud as the drilling mud travels from the top of the drill pipe assembly and to the drill bit. At deep hole depths, the temperature of the drilling mud at the time that it reaches the drilling bit can exceed 200° centigrade or even more. When this occurs, both the earth as well as the drilling mud heat the electronic components mounted to the drill pipe to such elevated temperatures that one or more of the electronic components rapidly fail. Upon component failure, the drill pipe, together with the electronic components, must be extracted from the hole and replaced with new electronic components. This, of course, is an exceedingly expensive operation.

A still further difficulty encountered when drilling holes is that the electronic components are exposed to shock and abrasion from rock and other debris carried by the drilling mud. Such shock and abrasion can damage or even destroy the electronic components thus necessitating extraction of the drill pipe and replacement of the electronic components.

Yet a further difficulty encountered when drilling holes is that the electronic components as well as the drilling pipe and production pipe are oftentimes exposed to corrosive elements, such as hydrogen sulfide. These corrosive elements effectively shorten the life expectancy of these various components.

### SUMMARY OF THE PRESENT INVENTION

In brief, the present invention provides a drill pipe assembly which overcomes all of the above-mentioned disadvantages of the previously known drill pipe assemblies.

In brief, the drill pipe assembly of the present invention comprises an elongated tubular drill pipe which is constructed of a rigid material, such as metal. The drill pipe is open at each end.

A layer of thermal insulation material is provided around the drill pipe between its ends. Preferably, the layer of thermal insulation material is provided around the outer periphery of the drill pipe although it may alternatively be provided around the interior periphery of the drill pipe or around both the inner and outer periphery.

Any conventional thermal insulation material may be used provided that the material does not interfere with electronic or pulsed sonic signals from the electronic components. Preferred thermal insulation materials include polymers, nonconductive composite materials, polyester resins, epoxies, fiberglass, carbon-based materials, vinyl ester resins and the like.

Electronic components are optionally mounted to the drill pipe, typically in a sleeve mounted to the outside of the drill pipe. In this event, the electronic components are sandwiched in between the thermal insulation material and the drill pipe.

In practice, the layer of thermal insulation material around the drill pipe reduces heat transfer from the earth, through the drill pipe and into the interior of the drill pipe. Consequently, the drilling mud which is pumped downwardly through the drill pipe is maintained at a cooler temperature when the drilling mud reaches the bottom of the hole at the drill bit than without the insulation layer. This, in turn, enables the drilling mud to maintain the electronic sensors typically mounted to the lowermost or first section of the drill pipe at a relatively low temperature even at hole depths exceeding 15,000 feet. This, in turn, prolongs the useful life of the electronic sensors.

Additionally, the thermal insulation material protects the electronic components from mechanical shock and abrasion during the drilling operation. The thermal insulation also protects the drill pipe as well as the electronic components from corrosive materials.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is a side view of a preferred embodiment of the invention;

FIG. 2 is a sectional view taken along line 2-2 in FIG. 1;

FIG. 3 is a view similar to FIG. 1, but showing the lowermost section of drill pipe; and

FIG. 4 is a sectional view taken along line 4-4 in FIG. 3.

### DETAILED DESCRIPTION OF A PREFERRED EMBODIMENT OF THE PRESENT INVENTION

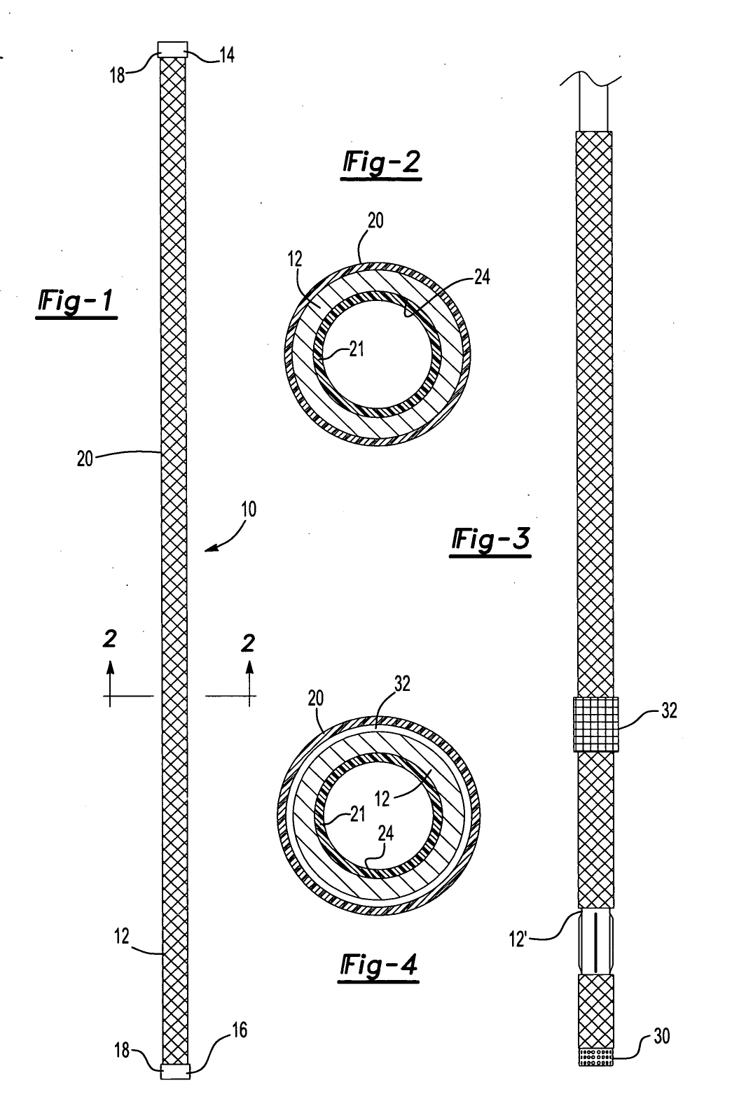

With reference first to FIG. 1, a preferred embodiment of a drill pipe assembly 10 of the present invention is shown. The drill pipe assembly 10 includes an elongated tubular drill pipe 12 that is open at both its upper end 14 and lower end 16. The drill pipe 12 is constructed of any conventional rigid material, such as steel. Furthermore, as used herein, the term “drill pipe” shall include both drill pipes as well as production pipes.

Each drill pipe 12 has a preset length, for example fifty feet. As the depth of the hole increases, sections of the drill pipe assembly 10 are added to the overall drill pipe assembly 10 as required. For this purpose, appropriate connectors 18 are provided at both the upper end 14 and lower end 16 of each drill pipe 12.

With reference now to FIGS. 1 and 2, a layer 20 of thermal insulation material is provided around at least a portion of the drill pipe 12. This layer 20 of thermal insulation material is preferably provided around an outer periphery 22 of the drill pipe 12. Optionally, a layer 21 of thermal insulation material may also be provided around an inner periphery 24 of the drill pipe 12.

With reference now to FIGS. 3 and 4, the lowermost section 12′ of the drill pipe assembly 10 is shown in which a cutter head 30 is mounted to the lower end 16 of the drill pipe 12. An electronic component assembly 32 is contained within a tubular cylindrical sleeve which in turn is mounted to the outer periphery 22 of the drill pipe 12. The layer 20 of thermal insulation material is then disposed around both the portion of the drill pipe 12 as well as the electronic component assembly 32. In doing so, the component assembly 32 is sandwiched in between the layer 20 of thermal insulation material and the outer periphery 22 of the drill pipe 12.

Any conventional material may be used to form the layers 20 and 21 of thermal insulation material. Acceptable thermal insulation material includes nonconductive composite materials, polymer materials, polyester resins, epoxy materials, fiberglass, vinyl ester resins, carbon-based materials and the like. The material selected for the thermal insulation layers 20 and 21 is also resistant to mechanical shock and abrasion as well as chemical corrosive elements, such as hydrogen sulfide. The insulating material is also selected so that it does not interfere with the electronic or sonic signals from the component package 32.

During a drilling operation, drilling mud is pumped downwardly through the interior of the drill pipe 12 and towards the cutter head 30. In the conventional fashion, the drilling mud lubricates the drilling head 30 and also serves to convey drilling debris upwardly through the drill hole along the outside of the drill pipe 12.

The layer 20 of thermal insulation material insulates the drilling mud as the drilling mud is pumped downwardly through the interior of the drill pipe 12 and toward the cutter head 30. The layer 20 of thermal insulation material thus maintains the drilling mud at a relatively cool temperature, even at deep drilling depths. This, in turn, enables the relatively cool drilling mud to maintain the electronic component assembly 32 mounted to the drill pipe 12 at a relatively cool temperature thus prolonging the life of the individual components in the electronic component package.

The thermal insulation layer 20 also protects the electronic component package from mechanical shock and abrasion during the drilling operation. Additionally, the insulation layer 20 and the layer 21, if present, protect the drill pipe as well as the electronic component package from corrosive elements.

From the foregoing, it can be seen that the present invention provides a drill pipe assembly which is simple in construction yet effective at use. Having described my invention, however, many modifications thereto will become apparent to those skilled in the art to which it pertains without deviation from the spirit of the invention as defined by the scope of the appended claims.

1. A drill pipe assembly comprising:
an elongated tubular drill pipe constructed of a rigid material, said drill pipe being open at each end, and
a layer of thermal insulation material provided around at least a portion of said drill pipe.

2. The invention as defined in claim 1 wherein said layer of thermal insulation material is provided around an outer periphery of said drill pipe.

3. The invention as defined in claim 1 wherein said layer of thermal insulation material is provided around an inner periphery of said drill pipe.

4. The invention as defined in claim 1 and comprising an electronic component package mounted to an outer periphery of said drill pipe, said package being sandwiched between said layer of thermal insulation material and said drill pipe.

5. The invention as defined in claim 1 wherein said layer of thermal insulation material comprises an electrically nonconductive composite material.

6. The invention as defined in claim 1 wherein said layer of thermal insulation material comprises a polymer material.

7. The invention as defined in claim 1 wherein said layer of thermal insulation material comprises a polyester resin.

8. The invention as defined in claim 1 wherein said layer of thermal insulation material comprises an epoxy material.

9. The invention as defined in claim 1 wherein said layer of thermal insulation material comprises fiberglass.

10. The invention as defined in claim 1 wherein said layer of thermal insulation material comprises vinyl ester resin.

11. The invention as defined in claim 1 wherein said layer of thermal insulation material comprises a carbon-based material.

12. The invention as defined in claim 1 wherein said thermal insulation material is resistant to mechanical shock and abrasion.

13. The invention as defined in claim 1 wherein said thermal insulating material is resistant to chemical corrosion.
